(19) United States
(12) Patent Application Publication
(10) Pub. No.: US 2020/0381178 A1
(43) Pub. Date: Dec. 3, 2020

(54) WIRELESS POWER TRANSMISSION APPARATUS FOR VEHICLE

(71) Applicants: Hyundai Motor Company, Seoul (KR); Kia Motors Corporation, Seoul (KR); AMOTECH CO., LTD., Incheon (KR)

(72) Inventors: Kyoung-Chun Kweon, Seoul (KR); Hong-Dae Jung, Suwon (KR); Dong-Hoon Lee, Yongin (KR); Woong-Yong Lee, Incheon (KR); Kil-Jae Jang, Seongnam (KR)

(21) Appl. No.: 16/701,381

(22) Filed: Dec. 3, 2019

(30) Foreign Application Priority Data
May 28, 2019 (KR) 10-2019-0062489

(51) Int. Cl. H01F 38/14; H01F 27/36; H02J 50/20; H02J 50/80; H01F 27/28; H01F 27/08; B60L 1/00; H04B 5/00

(52) U.S. Cl. CPC H01F 38/14; H01F 27/365; H02J 50/20; H04B 5/0037; H01F 27/28; H01F 27/08; B60L 1/006; H02J 50/80

(57) ABSTRACT

A wireless power transmission apparatus for a vehicle is provided. The apparatus includes a magnetic field shielding sheet that is disposed to shield a magnetic field and a wireless power transmission antenna that is attached to one surface of the magnetic field shielding sheet. Additionally, a wireless communication antenna is attached to the surface of the magnetic field shielding sheet to which the wireless power transmission antenna is attached.

### CROSS-REFERENCE(S) TO RELATED APPLICATIONS

This application claims priority to Korean Patent Application No. 10-2019-0062489, filed on May 28, 2019, which is incorporated herein by reference in its entirety.

### BACKGROUND

### Field of the Invention

The present disclosure relates to an apparatus capable of wirelessly transmitting a power to a smart device in a vehicle, and more particularly, to an apparatus that prevents a wireless charging efficiency from being deteriorated even if both a near field communication (NFC) antenna for data communication and a wireless power transmission antenna (WPC) for wireless charging are provided therein.

### Description of the Related Art

Recently, there is an increasing trend to use an electronic device having a battery that is charged with an external power, for example, a mobile terminal, such as a portable phone, a smart phone, a tablet personal computer (PC), a notebook computer, a terminal for digital broadcasting, a personal digital assistant (PDA), a portable media player (PMP), or a navigation, and a battery of an electronic device is often charged using a charger during movement in a dynamic space, such as a vehicle. In addition to charging using a charging cable, a non-contact type charging system that charges a battery of an electronic device using a wireless power transmission system in a vehicle has been developed.

In addition to the wireless charging, an electronic device may also have a data transmission function via near field communication (NFC). The NFC, which is one of radio-frequency identification (RFID) that is an electronic tag, is a non-contact type near field communication module using 13.56 MHz frequency band, and it corresponds to a technology that transmits data between terminals in a short distance of 10 cm. By transmitting various types of vehicle information to the electronic device side using such NFC technology, a user is capable of conveniently detecting and controlling the vehicle information using a portable device.

For this, an NFC antenna integrated wireless charger for not only wireless charging but also NFC function in a vehicle enables a driver to enter/exit or start a vehicle using a smart phone without the necessity of a vehicle key, sense the smart phone via NFC communication when the smart phone is placed on a wireless charging pad, and transmit received data to a smart phone authentication controller. Accordingly, through the authentication controller, the driver may be recognize and a door open/close and a start of the vehicle may be performed.

FIG. 1 is a diagram illustrating an example of an NFC antenna integrated wireless charger in the related art. With reference to FIG. 1, the NFC antenna integrated wireless charger in the related art includes housings 11, 12, and 13 to build components therein, a circuit board 14, a heat dissipation board 15, a coil for wireless charging and a magnetic field absorption material 16, and a PCB 17 for NFC in a laminated structure.

As described above, to separately configure the NFC antenna, it is required to configure and deploy a printed circuit board separately from a wireless changing Tx coil. In particular, due to the location of the existing PCB type NFC antenna that is located on an upper portion of the wireless charging Tx coil, the wireless charging Tx coil and a Rx coil of a terminal side become distant from each other, and thus charging efficiency deteriorates. On the other hand, if the NFC antenna circuit board is disposed on a lower side of the wireless charging Tx coil, the NFC antenna is unable to operate normally due to a shielding sheet installed to operate the Tx coil, and thus the installation location of the NFC antenna is limited.

In the related art, sendust has been used as a material of a Tx shielding member, and recently, magnesium-zinc (Mn—Zn) ferrite has also been used as the material of the Tx shielding member. However, the sendust is unable to be used in the NFC band frequency, and the Mn—Zn ferrite has magnetic characteristics abruptly deteriorating in the NFC usage band of 13.56 MHz although it shows good characteristics in the band of ˜500 kHz. Due to such limited characteristics of the material, the Mn—Zn ferrite is not suitable for the NFC antenna.

The foregoing description of the background technology is intended merely to help the understanding of the background of the present disclosure, and is not intended to mean that the present disclosure falls within the purview of the related art that is already known to those of ordinary skill in the art.

### SUMMARY

The present disclosure provides a wireless power transmission apparatus for a vehicle, which may prevent a wireless charging efficiency from being deteriorated even when both a near field communication (NFC) antenna for data communication and a wireless power transmission antenna (WPC) for wireless charging are provided therein.

Further, exemplary embodiments of the present disclosure provide a wireless power transmission apparatus for a vehicle, which may shield both a near field communication antenna and a wireless power transmission antenna for wireless charging using one shielding sheet.

Other objects and advantages of the present disclosure may be understood by the following description, and become apparent with reference to the exemplary embodiments of the present disclosure. Also, it is obvious to those skilled in the art to which the present disclosure pertains that the objects and advantages of the present disclosure may be realized by the means as claimed and combinations thereof.

In one aspect of the present disclosure, a wireless power transmission apparatus for a vehicle may include a magnetic field shielding sheet configured to shield a magnetic field; a wireless power transmission antenna attached to one surface of the magnetic field shielding sheet; and a wireless communication antenna attached to the surface of the magnetic field shielding sheet to which the wireless power transmission antenna is attached.

The wireless power transmission antenna and the wireless communication antenna may be disposed on the same plane. The wireless power transmission antenna may include a flat type coil wound to form a hollow portion, and the wireless communication antenna may be disposed on the hollow portion side formed by the flat type coil. The wireless power transmission antenna may include a plurality of flat type coils, and a plurality of wireless communication antennas may be disposed in respective hollow portions formed by the flat type coils, wherein the deployed wireless communication antennas may be connected in series.

Additionally, the wireless power transmission antenna may include a flat type coil wound to form a hollow portion therein, and the wireless communication antenna may be disposed to surround an outer circumference of the flat type coil. The wireless power transmission antenna may include a plurality of flat type coils, and a plurality of wireless communication antennas may be disposed to surround outer circumferences of the flat type coils, respectively, wherein the deployed wireless communication antennas may be connected in series.

The wireless power transmission antenna may include a plurality of flat type coils wound to form hollow portions, respectively, and the wireless communication antenna may be disposed to surround outer circumferences of the plurality of flat type coils together. The wireless communication antenna may generally be provided in the form of a wave pattern on a plane.

The magnetic field shielding sheet is any one of an amorphous ribbon sheet, a ferrite sheet, and a polymer sheet. The magnetic field shielding sheet is a nickel-zinc (Ni—Zn) ferrite sheet. The wireless power transmission apparatus may further include a plate-shaped heat dissipation plate disposed on the one surface of the magnetic field shielding sheet. The heat dissipation plate is any one of a copper plate, an aluminum plate, and a graphite sheet.

In another aspect of the present disclosure, a wireless power transmission apparatus for a vehicle may include a magnetic field shielding sheet configured to shield a magnetic field; a wireless power transmission antenna disposed on one surface of the magnetic field shielding sheet; and a wireless communication antenna disposed on the surface of the magnetic field shielding sheet on which the wireless power transmission antenna is disposed. The wireless power transmission antenna and the wireless communication antenna may be disposed not to overlap each other in a direction that is vertical to a plane of the magnetic field shielding sheet.

According to the wireless power transmission apparatus for a vehicle of the present disclosure, a separate NFC antenna PCB may be omitted, and thus costs for materials and processes may be reduced. Further, the wireless charging efficiency may be improved up to 2.7% in comparison with the existing laminate structures. In addition, shielding of both NFC and WPC antennas may be performed using one shielding sheet. Since the NFC antenna and the WPC antenna may be disposed to prevent overlap each other, even NFC functions may be added while the volume of the existing Tx module is maintained, and during their respective operations, interference may be maximally reduced.

It is to be understood that both the foregoing general description and the following detailed description of the present disclosure are exemplary and are intended to provide further explanation of the disclosure as claimed.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view illustrating an NFC antenna integrated wireless charger in the related art;

FIG. 2 is a detailed view of a wireless power transmission apparatus for a vehicle according to an exemplary embodiment of the present disclosure;

FIGS. 3 and 4 are views partially illustrating one configuration of a wireless power transmission apparatus for a vehicle of FIG. 2 according to an exemplary embodiment of the present disclosure;

FIG. 5 is a view illustrating a wireless power transmission apparatus for a vehicle according to another exemplary embodiment of the present disclosure; and

FIGS. 6 and 7 are views illustrating a wireless power transmission apparatus for a vehicle according to still another exemplary embodiment of the present disclosure.

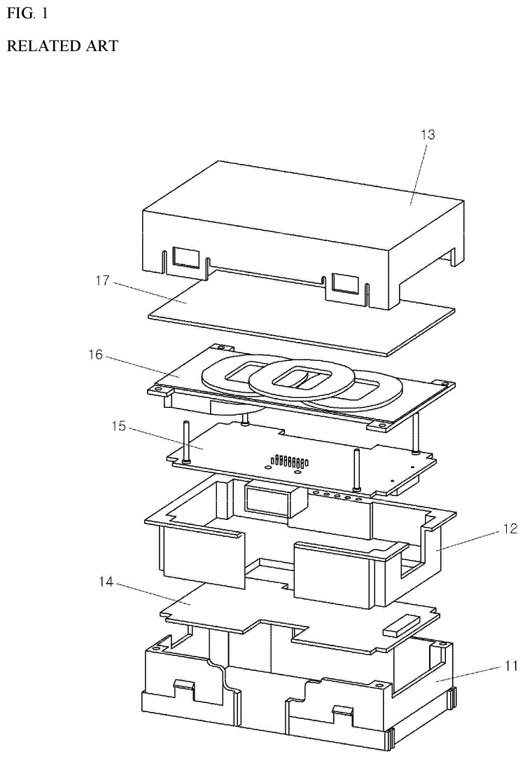

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The above-described objects, features, and advantages of the present disclosure will be described in detail with reference to the accompanying drawings, and accordingly, those of ordinary skill in the art to which the present disclosure pertains will be able to fully understand and easily embody the technical concept of the present disclosure.

In describing the exemplary embodiments of the present disclosure, detailed description of well-known technologies related to the present disclosure will be reduced or omitted in the case where it is determined that it obscures the subject matter of the present disclosure in unnecessary detail.

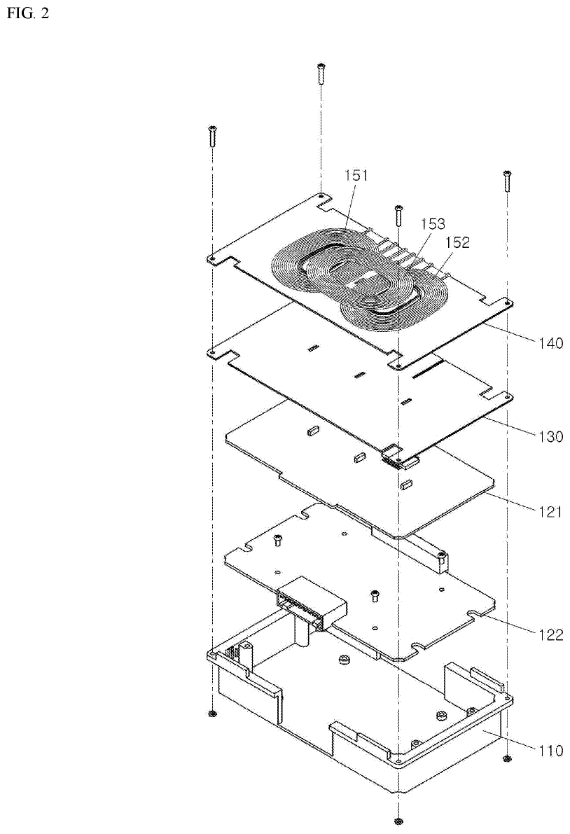

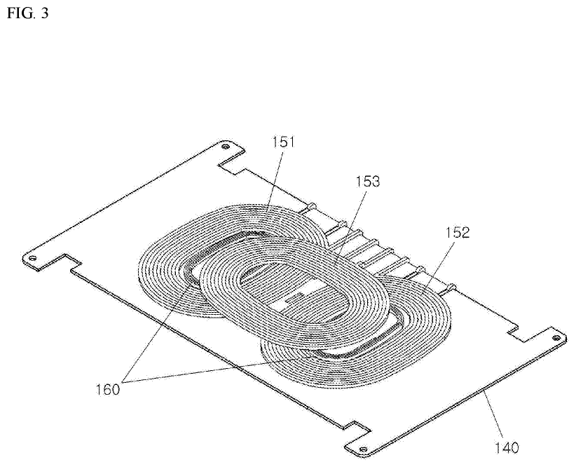

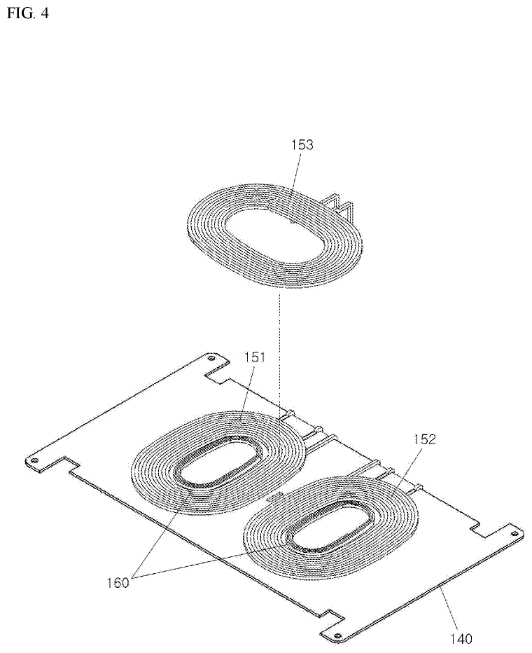

FIG. 2 is a detailed view of a wireless power transmission apparatus for a vehicle according to an exemplary embodiment of the present disclosure, and FIGS. 3 and 4 are views partially illustrating one configuration of a wireless power transmission apparatus for a vehicle of FIG. 2. Hereinafter, with reference to FIGS. 2 to 4, a wireless power transmission apparatus for a vehicle according to an exemplary embodiment of the present disclosure will be described.

The wireless power transmission apparatus according to the present disclosure is provided in a vehicle to make it possible to perform data communication with an electronic device, such as a smart device, through an NFC function together with a WPC function capable of wirelessly charging the electronic device. Accordingly, in the wireless power transmission device, it is required to build an antenna unit including an antenna for charging a smart device using wireless power transmission and an antenna for wireless communication for the NFC function.

In the related art, due to spatial limitations, the wireless power transmission antenna and the wireless communication antenna are required to be configured in a laminated form. However, in this case, the wireless charging efficiency may deteriorate, and the wireless power transmission apparatus according to the present disclosure may improve this deficiency and perform both the two functions as described above.

As illustrated in FIG. 2, a housing 110 for building an antenna unit therein is provided, and circuit boards 121 and 122 for electrical connection for the antenna unit and power are configured. However, it is not necessary to separately configure a PCB for NFC. Further, the antenna unit including the wireless power transmission antenna and the wireless communication antenna 160 may be attached onto a magnetic field shielding sheet 140.

The magnetic field shielding sheet 140 shields a magnetic field that is generated by the antenna unit. In the related art, the wireless power transmission antenna and the wireless communication antenna are configured separately and deployed in lamination, and thus separate shielding sheets are required. According to the wireless power transmission apparatus according to the present disclosure, the wireless power transmission antenna and the wireless communication antenna may be disposed together on one magnetic field shielding sheet.

As a result, both the wireless charging function and the wireless communication function may be performed without deteriorating the wireless charging efficiency. Accordingly, the wireless power transmission antenna and the wireless communication antenna may be disposed not to overlap each other in a direction that is vertical to a plane on which the magnetic field shielding sheet 140 is formed, and may be disposed on the same plane of the same surface of the magnetic field shielding sheet 140.

The magnetic field shielding sheet may be any one of an amorphous ribbon sheet, a ferrite sheet, and a polymer sheet, and more preferably, it may be possible to configure a Ni—Zn ferrite sheet capable of satisfying both the wireless charging function and the NFC function as the magnetic field shielding sheet, and thus the magnetic field shielding sheet may perform a functions thereof more accurately in the NFC usage band.

In an exemplary embodiment, the wireless power transmission antenna attached to one surface of the magnetic field shielding sheet 140 (e.g., a first surface) may include flat type coils 151, 152, and 153 wound to form hollow portions. In other words, the winding of the coils results in a void in a center thereof. As an example, two flat type coils 151 and 152 may be directly attached to the magnetic field shielding sheet 140, and the other flat type coil 153 may be laminated to overlap the two flat type coils.

In other words, the wireless power transmission antenna, which is disposed on the same plane as that of the wireless communication antenna 160 and disposed not to overlap the wireless communication antenna in a direction that is vertical to the plane, may include the flat type coils 151 and 152 that are directly attached to the magnetic field shielding sheet 140. Accordingly, the wireless communication antenna 160 according to an exemplary embodiment may be disposed on the hollow portion sides formed by the flat type coils 151 and 152 that are directly attached to the magnetic field shielding sheet 140, and thus it may perform the WPC and NFC functions without deteriorating the efficiency. In other words, a wireless communication antenna 160 may be disposed in the center of each wound coil (151, 152) where the void due to the winding of the coil is formed.

Particularly, when a pair of wireless power transmission antennas 151 and 152 is attached to the magnetic field shielding sheet 140 as exemplified above and as shown in FIG. 3, a plurality of wireless communication antennas 160 may be disposed respectively on the hollow portion sides formed by the flat type coils 151 and 152 directly attached to the magnetic field shielding sheet 140. Further, the wireless communication antennas 160 disposed as described above may be connected in series.

In addition, a plate-shaped heat dissipation plate 130 may be disposed on one surface of the magnetic field shielding sheet 140 to effectively dissipate heat, and the heat dissipation plate 130 may be disposed on an opposite surface to the surface onto which the antenna unit of the magnetic field shielding sheet 140 is attached (e.g., a second surface of the magnetic field shielding sheet 140). Hereinafter, the wireless charging efficiency of the wireless power transmission apparatus for a vehicle according to the present disclosure as described above will be described with reference to Tables 1 and 2 as compared with the existing technology.

Particularly, coils 1, 2, and 3 refer to the flat type coils 151, 152, and 153, respectively, and powers applied to a wireless charger are of 5 W, 10 W, and 15 W. The charging efficiency may be calculated through comparison of the powers charged in smart phones.

TABLE 1

| | | | | NFC Antenna according to the | | |
|---|---|---|---|---|---|---|
| | Existing PCB type NFC Antenna | | | present disclosure | | |
| Power | Coil 1 | Coil 2 | Coil 3 | Coil 1 | Coil 2 | Coil 3 |
| 5 W | 53.0% | 53.4% | 53.7% | 55.3% | 54.9% | 56.1% |
| 10 W | 63.9% | 63.1% | 63.8% | 65.5% | 65.9% | 66.4% |
| 15 W | 61.3% | 60.9% | 61.4% | 62.3% | 62.1% | 62.6% |

As shown in the table, the present disclosure has improved charging efficiencies at the powers of 5 W, 10 W, and 15 W compared to the existing technology in which PCBs for NFC are laminated. Accordingly, the wireless charging time of a smart phone battery may be decreased. Further, the antenna performance was evaluated with a prototype according to the present disclosure.

In Table 2 below, UCL, TOPAZ, ULTRA LIGHT, and EV1 refer to chip models (card types) for NFC tag usage, and they have respective performance specification standards. For example, a UCL product should operate minimally in 10 mm or greater in a read mode. Ultralight, EV1, and the like were diversely used for a vehicle in accordance with applications. This test was performed with 4 types of products, and in the case of using Ni—Zn ferrite, satisfactory test results were obtained in all. Even in a card mode, satisfactory results were showed in all with respect to the minimum standards.

TABLE 2

| Reader Mode | | | Card Mode | | |
|---|---|---|---|---|---|
| | Mn—Zn | Ni—Zn | | Mn—Zn | Ni—Zn |
| Spec. | ferrite | ferrite | Spec. | ferrite | ferrite |
| UCL(Min. 10) | 12 | 12 | 0, 0, 0(min. 8.8) | 62.18 | 71.87 |
| Topaz(Min. 20) | 26 | 35 | 1, 0, 0(min. 7.2) | 33.34 | 41.65 |
| Ultra-light(Min. 30) | 28 | 42 | 2, 0, 0(min. 5.6) | 12.16 | 27.01 |
| EVI(Min. 15) | 25 | 26 | 3, 0, 0(min. 4.0) | 8.17 | 13.98 |

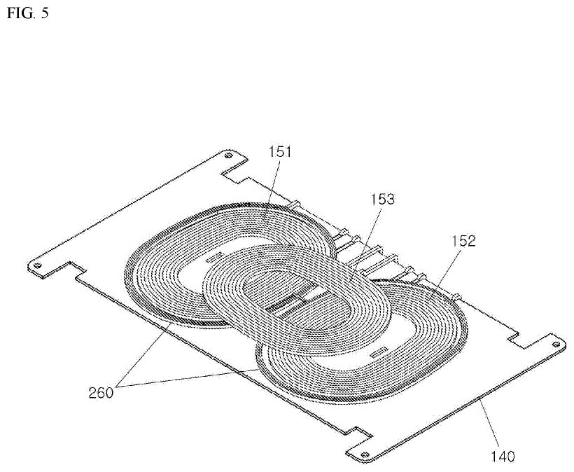

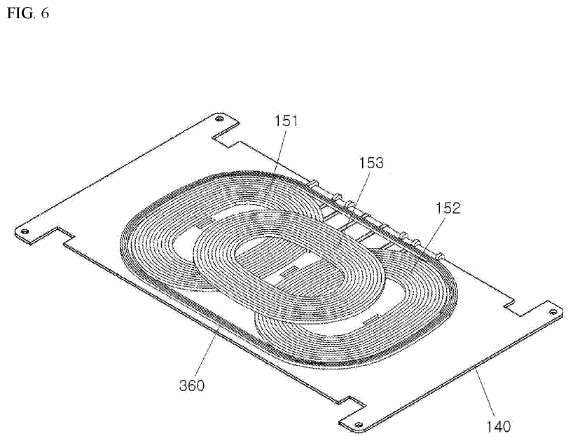

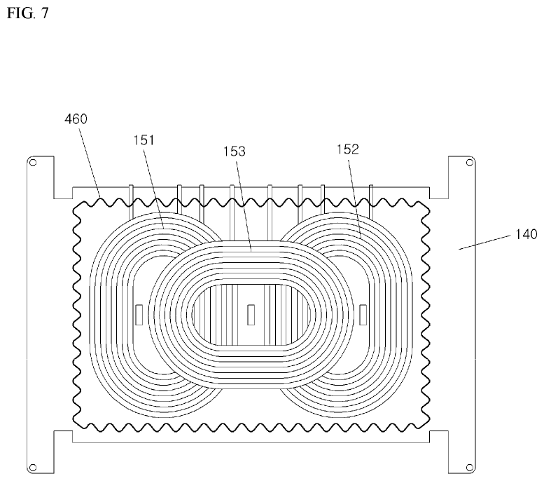

Furthermore, FIG. 5 is a view illustrating a wireless power transmission apparatus for a vehicle according to another exemplary embodiment of the present disclosure, and FIGS. 6 and 7 are views illustrating a wireless power transmission apparatus for a vehicle according to still another exemplary embodiment of the present disclosure.

The wireless power transmission apparatus for a vehicle according to another exemplary embodiment has a different deployment of the wireless communication antenna in comparison with the wireless power transmission apparatus according to the previous exemplary embodiment, and thus explanation of other configurations will be omitted. Even in another exemplary embodiment, in the same manner as the above-described exemplary embodiment, a wireless communication antenna may be disposed on the same plane as that of a wireless power transmission antenna without overlapping in a direction that is vertical to the plane of the magnetic field shielding sheet 140.

The wireless communication antenna 260 according to an exemplary embodiment of FIG. 5 may be disposed to surround an outer circumference of the flat type coil, and when the wireless power transmission antenna includes a plurality of flat type coils 151 and 152 attached to the magnetic field shielding sheet 140, a plurality of wireless communication antennas may be disposed to surround outer circumferences of the flat type coils 151 and 152, respectively. Further, the disposed wireless communication antennas 260 may be connected in series.

Furthermore, a wireless communication antenna 360 according to an exemplary embodiment of FIG. 6 may be disposed to surround outer circumferences of the flat type coils 151 and 152 attached to the magnetic field shielding sheet 140 together. A wireless communication antenna 460 according to an exemplary embodiment of FIG. 7 may be generally provided in the form of a wave pattern on a plane.

Accordingly, the length of the wireless communication antenna becomes greater than that according to the exemplary embodiment of FIG. 6, and thus more coils may be wound within a limited area to improve the NFC sensing performance. Although it is illustrated that the wireless communication antenna 460 includes a single fold of coil for convenience, the wireless communication antenna 460 may be composed of a plurality of folds of coil that overlap each other. Further, the width of a unit wave may be in the range of about 1,000 μm to 10 cm, and the height of the wave may be in the range of about 100 μm to 8,000 μm.

As described above, according to the wireless power transmission apparatus for a vehicle according to the present disclosure, since the wireless communication antenna may be disposed on the same plane as that of the wireless power transmission antenna without overlapping each other, the WPC and NFC functions may be performed without efficiency deterioration, and thus one magnetic field shielding sheet may be used to shield both the near field communication antenna and the wireless power transmission antenna.

While the present disclosure has been described with reference to the exemplified drawings, it will be apparent to those of ordinary skill in the art that the present disclosure is not limited to the described exemplary embodiments, and various changes and modifications may be made without departing from the spirit and scope of the present disclosure. Accordingly, such changes and modifications should belong to the claims of the present disclosure, and the right of the present disclosure should be construed based on the appended claims.

What is claimed is:

1. A wireless power transmission apparatus for a vehicle, comprising:
a magnetic field shielding sheet disposed to shield a magnetic field;
a wireless power transmission antenna attached to a first surface of the magnetic field shielding sheet; and
a wireless communication antenna attached to the first surface of the magnetic field shielding sheet.

2. The wireless power transmission apparatus according to claim 1, wherein the wireless power transmission antenna and the wireless communication antenna are disposed on the same plane.

3. The wireless power transmission apparatus according to claim 2, wherein the wireless power transmission antenna includes a flat type coil wound to form a hollow portion, and the wireless communication antenna is disposed within the hollow portion formed by the flat type coil.

4. The wireless power transmission apparatus according to claim 3, wherein the wireless power transmission antenna includes:
a plurality of flat type coils, and
a plurality of wireless communication antennas disposed in respective hollow portions formed by the flat type coils,
wherein the wireless communication antennas are connected in series.

5. The wireless power transmission apparatus according to claim 2, wherein the wireless power transmission antenna includes:
a flat type coil wound to form a hollow portion therein, and
the wireless communication antenna is disposed to surround an outer circumference of the flat type coil.

6. The wireless power transmission apparatus according to claim 5, wherein the wireless power transmission antenna includes:
a plurality of flat type coils; and
a plurality of wireless communication antennas disposed to surround outer circumferences of the flat type coils, respectively,
wherein the wireless communication antennas are connected in series.

7. The wireless power transmission apparatus according to claim 2, wherein the wireless power transmission antenna includes:
a plurality of flat type coils wound to form hollow portions, respectively, and
the wireless communication antenna is disposed to surround outer circumferences of the plurality of flat type coils together.

8. The wireless power transmission apparatus according to claim 7, wherein the wireless communication antenna is provided in the form of a wave pattern on a plane.

9. The wireless power transmission apparatus according to claim 3, wherein the magnetic field shielding sheet is any one of an amorphous ribbon sheet, a ferrite sheet, and a polymer sheet.

10. The wireless power transmission apparatus according to claim 9, wherein the magnetic field shielding sheet is a Ni—Zn ferrite sheet.

11. The wireless power transmission apparatus according to claim 3, further comprising a plate-shaped heat dissipation plate disposed on a second surface of the magnetic field shielding sheet.

12. The wireless power transmission apparatus according to claim 11, wherein the heat dissipation plate is any one of a copper plate, an aluminum plate, and a graphite sheet.

13. A wireless power transmission apparatus for a vehicle, comprising:
a magnetic field shielding sheet disposed to shield a magnetic field;
a wireless power transmission antenna disposed on a surface of the magnetic field shielding sheet; and
a wireless communication antenna disposed on the surface of the magnetic field shielding sheet on which the wireless power transmission antenna is disposed,
wherein the wireless power transmission antenna and the wireless communication antenna are disposed not to overlap each other in a direction that is vertical to a plane of the magnetic field shielding sheet.

14. The wireless power transmission apparatus according to claim 13, wherein the wireless power transmission antenna and the wireless communication antenna are disposed on the same plane.

15. The wireless power transmission apparatus according to claim 14, wherein the wireless power transmission antenna includes a flat type coil wound to form a hollow portion, and the wireless communication antenna is disposed within the hollow portion formed by the flat type coil.

16. The wireless power transmission apparatus according to claim 14, wherein the wireless power transmission antenna includes:
a flat type coil wound to form a hollow portion therein, and
the wireless communication antenna is disposed to surround an outer circumference of the flat type coil.

17. The wireless power transmission apparatus according to claim 14, wherein the wireless power transmission antenna includes:
a plurality of flat type coils wound to form hollow portions, respectively, and
the wireless communication antenna is disposed to surround outer circumferences of the plurality of flat type coils together.
